(19) United States
(12) Patent Application Publication
(10) Pub. No.: US 2023/0383142 A1
(43) Pub. Date: Nov. 30, 2023

(54) INTERMEDIARY PRE-APPLIED BEFORE SEALANT

(71) Applicant: Session Brasil Import and Export LTDA, Itajai City (BR)

(72) Inventors: Fernando Simioni Neves, Itajai City (BR); Evandro Anjiolino, Itajai City (BR)

(21) Appl. No.: 18/323,114

(22) Filed: May 24, 2023

(30) Foreign Application Priority Data
May 24, 2022 (BR) BR102022010118-3

(51) Int. Cl. C09D 191/08; C09D 7/20; C09D 7/45; C09D 5/00

(52) U.S. Cl. CPC C09D 191/08; C09D 7/20; C09D 7/45; C09D 5/00

(57) ABSTRACT

An intermediary being formed a coating layer after applying comprises a first surface and a second surface being corresponding to the first surface; the first surface having a first adhesive force for attaching to an inner surface of a tire; the second surface being configured to be covered and attached by a sealant, and the second surface and the sealant having a second adhesive force; wherein, when the sealant is separated and the second adhesive force is greater than the first adhesive force, the sealant and the coating layer are separated from the inner surface of the tire together, and when the sealant is separated and the first adhesive force is greater than the second adhesive force, the sealant is separated from the coating layer. The intermediary at least comprises a paraffin wax, a lanolin, a vegetable oil and an emulsifier being formed an emulsion.

### BACKGROUND OF THE INVENTION

### 1. Field of the Invention

The present invention relates to an intermediary pre-applied before sealant, and more particularly to an intermediary pre-applied before sealant for using for a tubeless tire.

### 2. Description of Related Art

Tubeless tires require the application of a sealant to the inside of the tire to seal the tires and prevent air from escaping if the tire is punctured. The sealant will dry out and must be removed and reapplied from time to time. But its removal from the tire is difficult as the sealant adheres tightly to the tire. Even it makes the tire dried and been hard.

U.S. patent Ser. No. 10/369,850 B2 shows a tire that is composed of a layer of self-sealing product, that is, in which the vast majority of punctures will not have consequences with regard to the internal inflation pressure. However, such document does not present a pre-sealant product being capable of preventing the sealant from drying out and facilitating the removal of the sealant in the reapplication phase.

Document CN 109130710 A shows an invention that describes a pneumatic tire with an internal sealing rubber layer and anti-puncture property and a method of manufacturing the same. Likewise, nothing is said about a pre-sealant product being capable of achieving the technical effect of the present invention.

U.S. Ser. No. 10/035,383 B2 is directed to a pneumatic tire comprising a radially outer circumferential rubber tread disposed on a supporting carcass, an inner liner rubber layer radially inwardly disposed on the supporting carcass, and a sealant layer adhered to and disposed inwardly of the rubber inner liner layer as a radially inner surface of the tire. It is not seen in this invention the presence of a pre-sealing product, which achieves the technical effects foreseen by the present invention.

Document US 2020371075 A1 shows thermoplastic resins of modified thermoplastic hydrocarbons, as well as methods of their manufacture and their uses in rubber compositions. Modified thermoplastic resins are modified by decreasing the relative amount of the dimer, trimer, tetramer, and pentamer oligomers compared to the corresponding unmodified thermoplastic resin polymers, resulting in a product that exhibits a greater change in the glass transition temperature of the elastomer(s) used in tire formulations. In some of the presented formulations, the described compositions may present paraffin, vegetable oil, mineral oil and other components. However, there is no provision for a pre-sealant product that must be applied to the tire before the sealant, facilitating the removal of the sealant.

U.S. Pat. No. 2,827,098 A discloses a self-sealing rubber composition being suitable for use as a puncture-sealing agent when adhered to a layer of punchable vulcanized rubber material, comprising at least one polyacrylate as a homopolymer of an alkyl acrylate having a C₂ to C₈ alkyl group or a copolymer of their mixtures or of one or more of these desacrylates with less than 50 percent of at least one other mono-olefinic monomer, or their blended or copolymerized mixtures. This document reveals a composition with sealing characteristics, without presenting any pre-sealant product.

Document GB 1092161 A discloses compositions for sealing containers comprising 16 to 92 parts by weight of an ethylene/vinyl acetate copolymer containing 15 to 40 weight percent vinyl acetate and having an inherent viscosity of 0.59 to 0.85 c.c./g at 30° C. and 5 to 75 parts by weight of a compatible resin of molecular weight 300 to 3000 being selected from hydroabietyl alcohol, terpene resin, wood pitch glycerol ester/maleic anhydride adduct, hydrogenated, disproportionate, or polymerized wood pitch and polyhydric alcohol esters of abietic acid. However, there is no disclosure for a pre-sealant product that must be applied to the tire before the sealant, facilitating the removal of the sealant.

In the above field, the formulation of various sealants has been proposed, but the formulation of an intermediary pre-applied sealant that achieves the technical effects that can be achieved with the present invention has not been observed.

### SUMMARY OF THE INVENTION

It is therefore one object of the invention to provide an intermediary pre-applied before sealant, the intermediary pre-applied before sealant being capable of being used inside the tire in a chamber before the application of most sealants in order to facilitate removal of the sealant when there is a need to remove and reapply the sealant.

It is another object of the invention to provide an intermediary pre-applied before sealant, the intermediary pre-applied before sealant being capable of increasing sealant slide and tire durability.

It is a further object of the invention to provide an intermediary pre-applied before sealant, the intermediary pre-applied before sealant being capable of having a thin layer, being without preventing the sealant from acting in its areas of application, helping to hydrate the tire and letting the rubber be soft and longer.

For achieving above and other objects, the invention provides an intermediary pre-applied before sealant being formed a coating layer after applying, comprising a first surface and a second surface being corresponding to the first surface; the first surface having a first adhesive force for attaching to an inner surface of a tire; the second surface being configured to be covered and attached by a sealant, and the second surface and the sealant having a second adhesive force; wherein, when the sealant is separated and the second adhesive force is greater than the first adhesive force, the sealant and the coating layer are separated from the inner surface of the tire together, and when the sealant is separated and the first adhesive force is greater than the second adhesive force, the sealant is separated from the coating layer. The intermediary pre-applied before sealant at least comprises a paraffin wax, a lanolin, a vegetable oil and an emulsifier being formed an emulsion.

The above and other objects, features and advantages of the invention will become apparent from the following detailed description taken with the accompanying drawings.

### BRIEF DESCRIPTION OF THE DRAWINGS

FIG. 1 is a perspective view in accordance with a first embodiment of the present invention being applied to a tire and a sealant;

FIG. 2 is an exploded view of FIG. 1; and

FIG. 3 is a partially sectional view of direction 3-3 of FIG. 1.

### DETAILED DESCRIPTION OF THE INVENTION

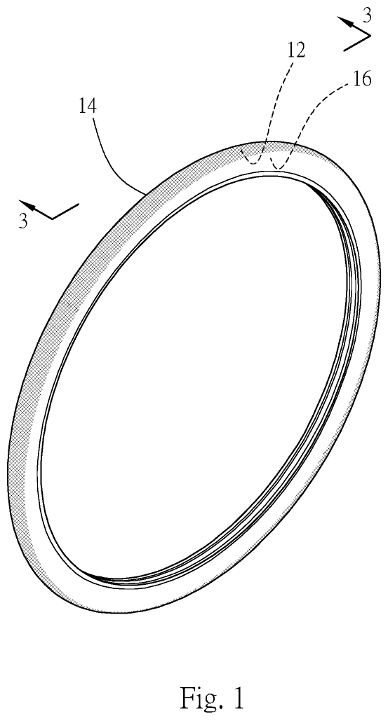

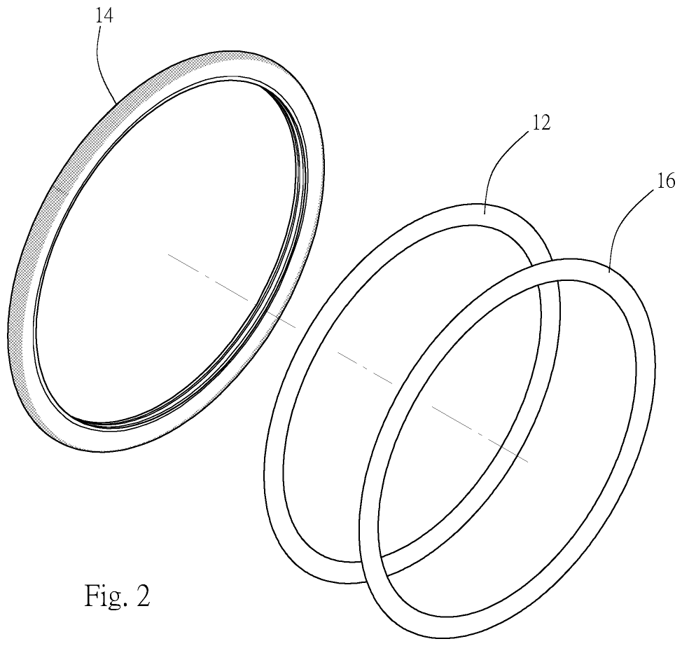

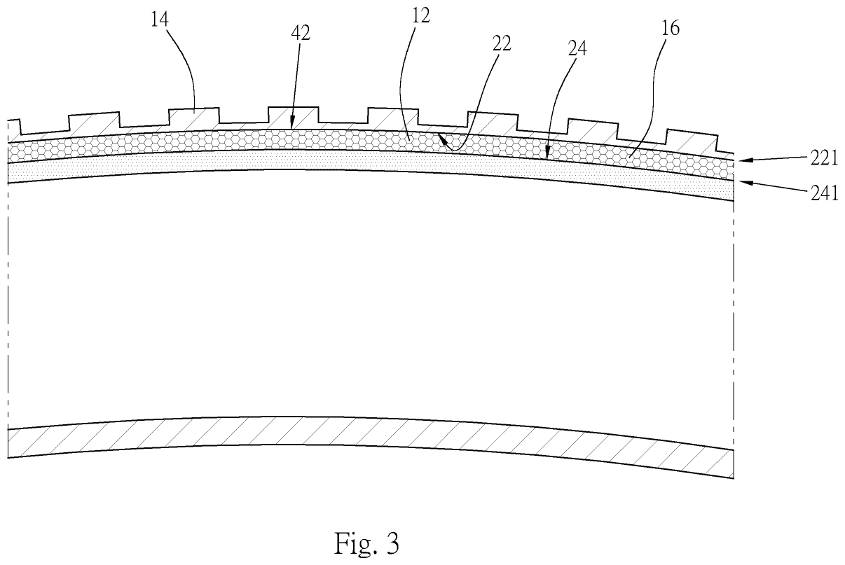

Referring to FIGS. 1 to 3, an intermediary pre-applied before sealant in accordance with a first preferred embodiment of the invention is formed a coating layer 12 after applying. The coating layer 12 comprises a first surface 22 and a second surface 24 being corresponding to the first surface 22.

In practice, an emulsion formed by the intermediary disclosed in the invention is applied to an inner surface 42 of a tire 14 such as a tire with tubeless technology. The first surface 22 has a first adhesive force 221 for attaching to the inner surface 42 of the tire 14. Preferably the coating layer 12 possesses a thin and uniform layer possessing smoothness.

At least 1˜2 hours after the coating layer 12 is formed, a conventional sealant is injected into the tire 14 in an appropriate amount, and then the tire 14 is rolled so that a part of the sealant 16 is coated on the second surface 24 of the coating layer 12 and a suitable liquid sealant still remains inside the tire 14. The second surface 24 and the attached sealant 16 have a second adhesive force 241.

When the tire 14 is punctured and there is a hole, the liquid sealant is pressed out of the hole by the high pressure gas inside the tire 14, and then the liquid sealant solidifies in the hole to have the effect of repair the tire 14.

When the tire 14 has not been punctured for a period of time, all the original sealant 16 is attached to the second surface 24 of the coating layer 12. At this time, the original sealant 16 should be removed, and then a new sealant is needed to injected again and a suitable liquid sealant still remains inside the tire 14 to maintain the effect of repairing the tire 14.

When the sealant 16 is released and the second adhesive force 241 is greater than the first adhesive force 221, the sealant 16 and the coating layer 12 are released from the inner surface 42 of the tire 14 together. When the sealant 16 is released and the first adhesive force 221 is greater than the second adhesive force 241, the sealant 16 is separated from the coating layer 12.

With the intermediary disclosed in the invention, we can easily release the sealant 16 without leaving the sealant 16 inside the tire 14.

The intermediary disclosed in the invention at least comprises a paraffin wax, a lanolin, a vegetable oil and an emulsifier being formed an emulsion. Wherein, preferably, the paraffin wax can have the property of repelling anionic products. The vegetable oil can include a palm oil such as a carnauba oil and/or other vegetable oil such as a sunflower oil, an olive oil, a canola oil, a coconut oil and etc. The emulsifier can be a cleaning agent/detergent. Preferably the emulsifier can be a solvent-free cleaning agent/detergent.

When the intermediary disclosed in the invention is made into an emulsion, an appropriate amount of water, such as distilled water, can be added to achieve the effects of emulsifying and adjusting the consistency. Preferably its weight percent component is 20˜40% paraffin wax, 5˜15% lanolin, 2˜8% palm oil, 30˜50% other vegetable oil, 2˜8% detergent and 5˜15% water. Its pH value is 7˜9.

The intermediary disclosed in the invention allows the liquid sealant to slide easily without hindering the efficacy of the sealant, also aids in tire hydration, and let the rubber be soft and longer. The intermediary can be sponged onto the inside of the tire to create friction with the tire to create a thin and even layer that helps to adhere to the tire and allows the sealant to work best. The intermediary disclosed in the invention can work at temperatures between −10° C. and 30° C., but the intermediary can also work at 50° C. without any physical change.

What is claimed is:

1. An intermediary being formed a coating layer after applying, comprising:
a first surface, the first surface having a first adhesive force for attaching to an inner surface of a tire;
a second surface being corresponding to the first surface, the second surface being configured to be covered and attached by a sealant, and the second surface and the sealant having a second adhesive force; and
wherein, when the sealant is separated and the second adhesive force is greater than the first adhesive force, the sealant and the coating layer are separated from the inner surface of the tire together, and when the sealant is separated and the first adhesive force is greater than the second adhesive force, the sealant is separated from the coating layer.

2. The intermediary of claim 1, at least comprising a paraffin wax, a lanolin, a vegetable oil and an emulsifier being formed an emulsion.

3. The intermediary of claim 2, wherein the vegetable oil comprises a palm oil and other vegetable oil.

4. The intermediary of claim 2, wherein the emulsifier is a detergent.

5. The intermediary of claim 3, wherein the emulsifier is a detergent.

6. The intermediary of claim 2, further comprising a water.

7. The intermediary of claim 3, further comprising a water.

8. The intermediary of claim 4, further comprising a water.

9. The intermediary of claim 5, further comprising a water.

10. The intermediary of claim 7, which comprises the following components by weight percentage:
A. 20˜40% paraffin wax;
B. 5˜15% lanolin;
C. 2˜8% palm oil;
D. 30˜50% other vegetable oil;
E. 2˜8% detergent;
F. 5˜15% water.

11. The intermediary of claim 9, which comprises the following components by weight percentage:
A. 20˜40% paraffin wax;
B. 5˜15% lanolin;
C. 2˜8% palm oil;
D. 30˜50% other vegetable oil;
E. 2˜8% detergent;
F. 5˜15% water.

12. The intermediary of claim 2, which has a pH value of 7˜9.

13. The intermediary of claim 3, which has a pH value of 7˜9.

14. The intermediary of claim 7, which has a pH value of 7˜9.

15. The intermediary of claim 9, which has a pH value of 7˜9.

16. The intermediary of claim 10, which has a pH value of 7˜9.

17. The intermediary of claim 11, which has a pH value of 7˜9.
